(19) United States
(12) Patent Application Publication
(10) Pub. No.: US 2005/0221766 A1
(43) Pub. Date: Oct. 6, 2005

(54) Method and apparatus to perform dynamic attestation

(76) Inventors: John P. Brizek, Placeville, CA (US); Robert N. Hasbun, Placerville, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/816,267

(22) Filed: Mar. 31, 2004

(51) Int. Cl. H04B 1/38

(52) U.S. Cl. 455/73

(57) ABSTRACT

Method and apparatus to perform dynamic attestation for a communication system are described.

### BACKGROUND

A computing platform may be vulnerable to tampering. For example, software applications to be executed by the computing platform may be accidentally or intentionally modified. As a result, techniques to measure and report the integrity of a system may be desirable.

### BRIEF DESCRIPTION OF THE DRAWINGS

FIG. 1 illustrates a block diagram of a system 100.

FIG. 2 illustrates a block diagram of a system 200.

FIG. 3 illustrates a block diagram of a system 300.

FIG. 4 illustrates a block flow diagram of a processing logic 400.

### DESCRIPTION OF SPECIFIC EMBODIMENTS

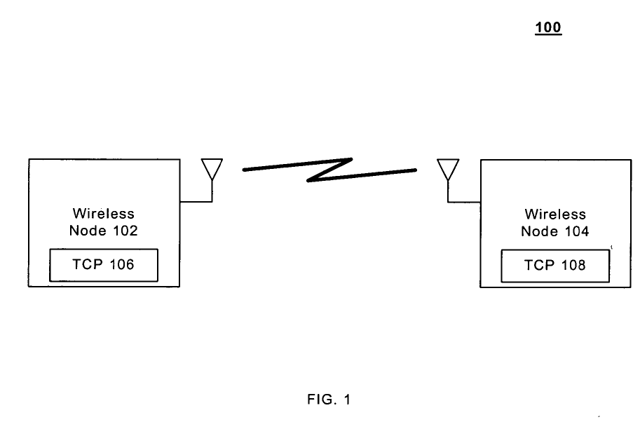

FIG. 1 illustrates a block diagram of a system 100. System 100 may comprise a communication system comprising a plurality of nodes. The term “node” as used herein may refer to any physical or logical entity having a unique address in the system. The unique address may comprise, for example, a network address such as an Internet Protocol (IP) address, device address such as a Media Access Control (MAC) address, and so forth. The embodiments are not limited in this context.

The plurality of nodes may be connected by varying types of communications media. The term “communications media” as used herein may refer to any medium capable of carrying information signals. Examples of communications media may include metal leads, semiconductor material, twisted-pair wire, co-axial cable, fiber optic, radio frequency (RF) spectrum, and so forth. The terms “connection” or “interconnection,” and variations thereof, in this context may refer to physical connections and/or logical connections.

The nodes may connect to the communications media using one or more input/output (I/O) adapters, such as a network interface card (NIC) or radio interface, for example. An I/O adapter may be configured to operate with any suitable technique for controlling communication signals between computer or network devices using a desired set of communications protocols, services and operating procedures, for example. The I/O adapter may also include the appropriate physical connectors to connect the I/O adapter with a suitable communications medium.

In one embodiment, for example, system 100 may be implemented as a wireless system having a plurality of nodes using RF spectrum to communicate information, such as a cellular or mobile system. In this case, one or more nodes shown in system 100 may further comprise the appropriate devices and interfaces to communicate information signals over the designated RF spectrum. Examples of such devices and interfaces may include omni-directional antennas and wireless RF transceivers. The embodiments are not limited in this context.

In one embodiment, system 100 may comprise a node 102 and a node 104. Nodes 102 and 104 may comprise, for example, wireless nodes configured to communicate information over a wireless communication medium, such as RF spectrum. Nodes 102 and 104 may represent a number of different wireless nodes, such as mobile or cellular telephone, a computer equipped with a wireless access card or modem, a handheld client device such as a wireless personal digital assistant (PDA), a wireless access point, a base station, a mobile subscriber center, and so forth. In one embodiment, for example, nodes 102 and/or 104 may comprise wireless devices developed in accordance with the Personal Internet Client Architecture (PCA) by Intel® Corporation. Although FIG. 1 shows a limited number of nodes, it can be appreciated that any number of nodes may be used in system 100. Further, although the embodiments may be illustrated in the context of a wireless communications system, the principles discussed herein may also be implemented in a wired communications system as well. The embodiments are not limited in this context.

In one embodiment, nodes 102 and 104 may each comprise a trusted computing platform (TCP), such as TCP 106 and TCP 108, respectively. The TCP may comprise a trusted platform to provide functions that can be used to enhance the security and performance of software applications. Software applications may comprise any set of computer program segments, such as operating systems (OS), boot code, user applications, drivers, and so forth.

As stated previously, a computing platform may be vulnerable to tampering. For example, software applications to be executed by the computing platform may be accidentally or intentionally modified. As a result, techniques to measure and report the integrity of a system may be desirable.

Conventional techniques directed to measuring system integrity may be unsatisfactory for a number of reasons. For example, conventional system may attempt to measure the integrity of a complete system, with the intent of attesting to the integrity of the complete system to an external authority. This may be time consuming and resource intensive. In another example, conventional systems attempt to establish centralized trust relationships. This may need a predetermined relationship in place prior to a device (e.g., handheld wireless device) connecting to a network. In yet another example, devices are becoming flexible enough to allow provisioning with software applications developed after the device has been manufactured. This increases the possibility of downloaded software applications disrupting the integrity of a device. Moreover, such downloaded applications may be delivered in discrete segments due to bandwidth and system limitations.

To solve these and other problems, TCP 106 and TCP 108 attempt to perform self-attestation in a distributed and dynamic fashion. TCP 106 and TCP 108 may be arranged to employ cryptographic functions when establishing trust between different entities, such as nodes, software applications, processing systems, and so forth. Typically, TCP 106 and TCP 108 may establish trust with an external authority, such as a carrier server or trusted code of the handset platform code set, for example. The embodiments are not limited in this context.

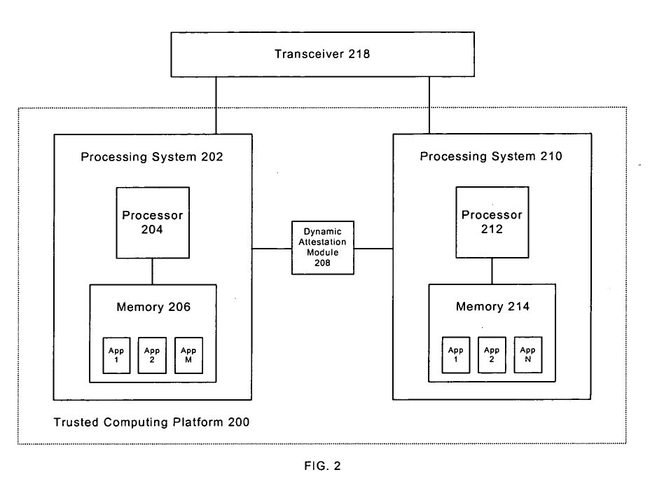

In one embodiment, the general architecture of TCP 106 and TCP 108 may be implemented in accordance with a Trusted Computing Group (TCG) document titled “Main Specification,” Version 1.1a, September 2001 (“TCG Specification”). The TCG Specification defines a TCP to provide trust and security capabilities while reducing the number of functions that must be trusted. The TCP may enable nodes 102 and 104 to determine the state of their internal software environment, and to seal data to a particular software environment if necessary. TCP 106 and 108 may be discussed in more detail with reference to FIG. 2.

FIG. 2 illustrates a block diagram of a system 200. System 200 may be representative of a TCP, such as TCP 106 and/or TCP 108. As shown in FIG. 2, TCP 200 may comprise a pair of processing systems 202 and 210. A processing system may refer to a processor and memory configured to execute computer program code, instructions or segments. Processing systems 202 and 210 may be connected to a dynamic attestation module (DAM) 208. TCP 200 may be connected to a radio transmitter/receiver (“transceiver”) 218, which is part of wireless nodes 102 and/or 104. Although FIG. 2 shows a limited number of elements, it can be appreciated that any number of elements may be used in TCP 200.

It is worthy to note that although system 200 includes multiple processing systems with multiple processors and multiple memory components, it can be appreciated that a single processor and memory may be implemented to perform the various operations discussed below, and still fall within the scope of the embodiments. For example, system 200 may be modified to comprise a single processor and memory, with the single processor and memory executing multiple processing threads. In this case, a first and second processing threads may be configured to operate as first processing system 202 and second processing system 210, respectively. The embodiments are not limited in this context.

In one embodiment, TCP 200 may comprise processing system 202. Processing system 202 may comprise a processor 204 and memory 206. Memory 206 may further comprise a plurality of applications 1-M.

In one embodiment, processing system 202 may comprise processor 204. Processor 204 may comprise any general purpose or dedicated processor, such as a network processor, embedded processor, microcontroller, controller, input/output (I/O) processor (IOP), digital signal processor (DSP), and so forth. In one embodiment, for example, processor 202 may comprise a Micro Signal Architecture (MSA) processor made by Intel Corporation. The MSA processor incorporates both DSP and microcontroller functionality in a single core. The embodiments, however, are not limited to this example.

In one embodiment, processing system 202 may comprise memory 206. Memory 206 may comprise machine-readable media and accompanying memory controllers or interfaces. The machine-readable media may include any media capable of storing instructions and data adapted to be executed by processor 202. Some examples of such media include, but are not limited to, read-only memory (ROM), random-access memory (RAM), programmable ROM, erasable programmable ROM, electronically erasable programmable ROM, double data rate (DDR) memory, dynamic RAM (DRAM), synchronous DRAM (SDRAM), embedded flash memory, and any other media that may store digital information. The embodiments are not limited in this context.

In one embodiment, TCP 200 may comprise processing system 210. Processing system 210 may comprise a processor 212 and memory 214. Memory 214 may further comprise a plurality of applications 1-N. Memory 214 of processing system 210 may be similar to corresponding memory 206 of processing system 202. Similar to processor 202, processor 212 may comprise any general purpose or dedicated processor suitable for a given implementation. In one embodiment, for example, processor 212 may comprise an XScale® (XSC) processor made by Intel Corporation. The embodiments, however, are not limited to this example.

In one embodiment, processing systems 202 and 210 may be connected to DAM 208. DAM 208 may perform the trusted functions for TCP 200. For example, DAM 208 may perform integrity, authentication, and attesting operations for processing system 202 and/or processing system 210. More particularly, DAM 208 may perform such trusted operations for one or more applications 1-M in memory 206 and/or applications 1-N in memory 214.

DAM 208 may be arranged to perform the trusted operations during boot operations when power is initially applied to processing systems 202 and 210. A processor (e.g., processor 204 or 212) may load and execute the attestation code for DAM 208 from a trusted area, such as a trusted boot read-only memory (ROM) for system 200 (e.g., memory 206 or memory 214). In addition, DAM 208 may perform trusted operations on a periodic basis or in response to an external event. For example, DAM 208 may perform trusted operations when a new application or code set is ready to be executed. This may be particularly desirable when a device or system has a large number of applications stored in memory. Additional examples of external events may include a user request, system request, power interruption, device failure, and so forth. The embodiments are not limited in this context.

In general operation, TCP 200 may operate to perform trusted functions between different entities, such as different processing systems or processing threads. The different processing systems or processing threads may be located on the same device, or different devices, based on a given implementation. TCP 200 provides an example of when two processing systems are located on the same device, such as wireless nodes 102 and/or 104.

In this example, processing system 202 may operate as a “closed” system. A closed system may have a limited number of functions, and its software cannot be changed or modified by another entity. Processing system 210 may operate as an “open” system. An open system may be used for general application processing, and its software can be changed or modified by another entity. The closed system may be used to measure and attest to the trustability of the open system. For example, closed processing system 202 may use DAM 208 to measure and attest to the trustability of open processing system 210. DAM 208 may use cryptographic operations to verify the integrity of one or more applications to be executed by processing system 210. If an application fails the integrity check, processing system 202 may disable access to transceiver 218 by processing system 210. In this manner, failure or corruption of processing system 210 is contained to a limited software environment, and therefore reducing the possibility of compromising node 104, node 106, or any other node of system 100.

One problem associated with conventional attestation is that it is defined as providing the trust state of a client device to a network or server. The current way to accomplish this is to, as much as possible, attest to a full platform. Attempting to measure and attest a full platform (e.g., all applications) on a wireless device, however, may have the deleterious effects of excessive boot time and a waste of power to undesirable levels for the device.

To solve these and other problems, DAM 208 may be operable to perform dynamic attestation. Dynamic attestation may refer to measuring and attesting to applications on a dynamic basis, such as just prior to execution of an application. For example, DAM 208 may be used to attest to a limited number of applications during boot operations. The limited number of applications may include, for example, the operating system for closed processing system 202. DAM 208 may attest to subsequent applications when they are ready to be executed. This may reduce boot time and power requirements for wireless nodes 102 and/or 104. In addition, DAM 208 may be configured to continue to monitor open processing system 210 after boot operations have been completed to perform other trusted operations.

In one embodiment, DAM 208 may perform attestation as defined by the TCG Specification. Alternatively, DAM 208 may perform local attestation. For example, an attested value may be signed and stored as part of TCP 200. DAM 208 may attest to a trust level for its own state using the stored attested value. DAM 208 may also attest to a trust level for different domains for TCP 200 and/or the device implementing TCP 200. The embodiments are not limited in this context.

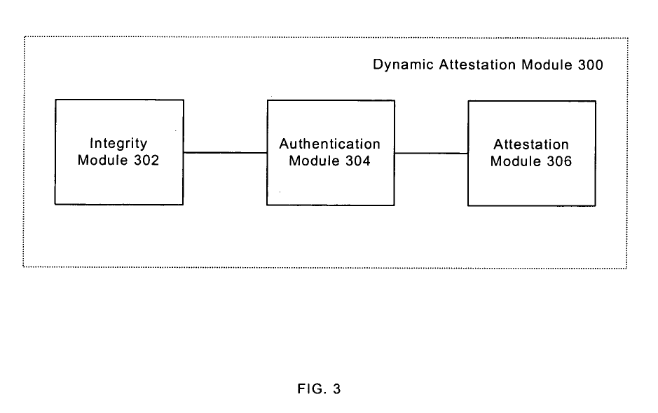

FIG. 3 illustrates a block diagram of a system 300. System 300 may be representative of a DAM, such as DAM 208. As shown in FIG. 3, DAM 300 may comprise an integrity module 302, authentication module 304, and an attestation module 306. Although FIG. 3 shows a limited number of elements, it can be appreciated that any number of elements may be used in DAM 300.

In one embodiment, DAM 300 may comprise integrity module 302. Integrity module 302 may perform an integrity check for an application, such as from applications 1-M or 1-N. DAM 300 may use any number of cryptographic operations to generate integrity information for the application. Integrity information may comprise, for example, a one-way hash of the data for the application. A one-way hash may comprise a number of fixed length that is unique for the hashed data. Any change in the data, even deleting or altering a single character, results in a different value. The content of the hashed data cannot, for all practical purposes, be deduced from the hash.

In one embodiment, for example, integrity module 302 may be configured to generate integrity information in accordance with the Internet Engineering Task Force (IETF) document titled “The MD5 Message-Digest Algorithm”, Request For Comment (RFC) 1321, April 1992 (“MD5 Specification”); or the IETF document titled “US Secure Hash Algorithm 1”, RFC 3174, September 2001 (“SHA-1 Specification”). The embodiments are not limited in this context.

In one embodiment, for example, integrity module 302 may generate integrity information for an application using a hashing algorithm defined in the SHA-1 Specification. Integrity module 302 may use SHA-1 to compute a condensed representation of a message or a data file. When a message of any length<2⁶⁴ bits is input, the SHA-1 produces a 160-bit output called a message digest. The message digest can then, for example, be input to a signature algorithm which generates or verifies the signature for the message. Signing the message digest rather than the message often improves the efficiency of the process because the message digest is usually much smaller in size than the message. The same hash algorithm must be used by the verifier of a digital signature as was used by the creator of the digital signature. Any change to the message in transit will, with very high probability, result in a different message digest, and the signature will fail to verify. The SHA-1 is called secure because it is computationally infeasible to find a message which corresponds to a given message digest, or to find two different messages which produce the same message digest. Any change to a message in transit will, with very high probability, result in a different message digest, and the signature will fail to verify.

In one embodiment, DAM 300 may comprise authentication module 304. Authentication module 304 may be configured to perform source validation for the integrity information generated by integrity module 302. In one embodiment, for example, authentication module 304 may be configured to perform source validation using a public key encryption algorithm. An example of a public key encryption algorithm suitable for use with DAM 300 may include a Rivest Shamir Adelman (RSA) public key encryption algorithm. The embodiments are not limited in this case.

Public-key cryptography may facilitate encryption and decryption of the integrity information. Encryption is the process of transforming information so it is unintelligible to anyone but the intended recipient. Decryption is the process of transforming encrypted information so that it is intelligible again. A cryptographic algorithm, also called a cipher, is a mathematical function used for encryption or decryption. The cryptographic algorithm uses a number called a key that must be used with the algorithm to produce an encrypted result or to decrypt previously encrypted information. Public-key encryption (also called asymmetric encryption) associates a pair of keys with an entity that needs to authenticate its identity electronically or to sign or encrypt data. For example, the pair of keys may include a public key and a private key. Each public key is published, and the corresponding private key is kept secret. Data encrypted with a public key can be decrypted only with the corresponding private key, and vice versa. The latter case may be desirable for certain digital signature operations. The embodiments are not limited in this context.

In one embodiment, authentication module 304 may use public key cryptography to encrypt and decrypt the message digest generated by integrity module 302. Authentication module 304 may receive the message digest, and attach a digital signature to the message digest by encrypting the message digest with the public key or private key of open processing system 210. Authentication module 304 of processing system 202 may use the corresponding private key or public key, respectively, to decrypt the message digest.

In one embodiment, DAM 300 may comprise attestation module 306. Attestation module 306 may attest to the decrypted message digest from authentication module 304. Attestation module 306 may receive the decrypted message digest, and instruct integrity module 302 to retrieve a second message digest for the original target application, e.g., an application 1-N of open processing system 210. The second message digest may have been previously generated by a trusted authority. A trusted authority may comprise, for example, a validation entity. The trusted authority may use the same cryptographic operations used by integrity module 302 of processing system 210. The second message digest may be stored in a trusted area of the platform, such as a trusted boot ROM, for example. Integrity module 302 of DAM 300 may retrieve the second message digest. Integrity module 302 may send the second message digest to attestation module 306. Attestation module 306 may receive the second message digest, and compare the decrypted message digest with the second message digest. If the message digests are the same, then the integrity of the original application has been confirmed, and subsequent operations of processing system 210 may proceed as normal. If the pair of message digest are not the same, however, processing system 202 may assume that the integrity of the application to be executed by open processing system 210 has been breached, and security precautions may be taken to ensure the application does not interfere with other operations of node 102, node 104, or any other node of system 100. Attestation module 306 may generate an attestation value to reflect the results of the comparison.

Operations for the above systems may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

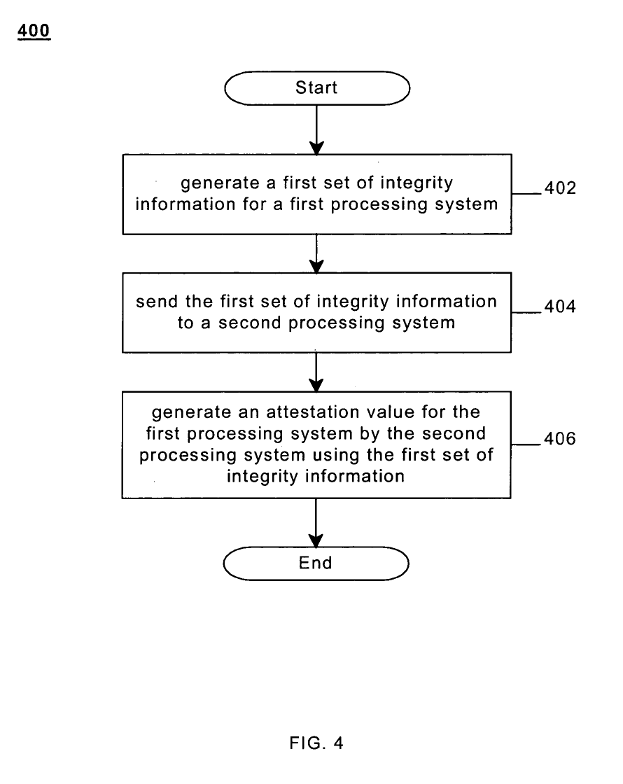

FIG. 4 illustrates a block flow diagram for a programming logic 400. FIG. 4 illustrates a programming logic 400 that may be representative of the operations executed by one or more systems described herein, such as systems 100-300. As shown in programming logic 400, a first set of integrity information may be generated for a first processing system at block 402. The first set of integrity information may be sent to a second processing system at block 404. An attestation value may be generated for the first processing system by the second processing system using the first set of integrity information at block 406.

In one embodiment, the first set of integrity information may be generated by selecting an application from a plurality of applications to be executed by the first processing system. The first set of integrity information for the application may be generated using a cryptographic algorithm. For example, the cryptographic algorithm may be defined by the SHA Specification or MD5 Specification.

In one embodiment, the attestation value may be generated by retrieving a second set of integrity information for the first processing system. The second set of integrity information may be a set of integrity information previously generated by a trusted authority. The second set of integrity information may be stored in a trusted area of system 200. The second set of integrity information may be retrieved from the trusted area. The first set of integrity information may be compared with the second set of integrity information. The attestation value may be generated in accordance with the comparison.

In one embodiment, the first set of integrity information may be sent to a second processing system. Prior to sending, the integrity information may be encrypted using a public key for the first processing system. The encrypted integrity information may be sent to the second processing system.

In one embodiment, the encrypted integrity information may be authenticated by the second processing system prior to generating the attestation value. The second processing system may receive the encrypted integrity information. The second processing system may retrieve a private key for the first processing system. The encrypted integrity information may be encrypted using the private key. The encrypting and decrypting may be an RSA public key encryption algorithm, for example.

The operation of the above described systems and associated programming logic may be better understood by way of example. Assume wireless node 102 and/or 104 is a handheld wireless device having multiple processing systems, such as a cell phone. When the cell phone is initially powered on, TCP 200 starts a set of trusted boot operations. The trusted boot operations are to ensure that the software applications for the device have not been tampered with or corrupted, such as from a hacker or virus. The trusted boot operations begin with initializing a limited number of critical applications, such as the operating system for closed processing system 202. Assume closed processing system 202 comprises an MSA processor that is a trusted component of the system. Closed processing system 202 begins by performing a cryptographic check of the MSC code needed to boot system 202. If closed processing system 202 passes the cryptographic check of its own systems, it completes the boot operation for system 202. The public and/or private keys for closed processing system 202 and open processing system 210 may then be loaded.

Once the boot operation for closed processing system 202 has been completed, open processing system 210 begins its own boot operations. Assume that open processing system 210 comprises an XSC processor. Open processing system 210 begins by performing a cryptographic check of a limited number of applications needed to complete boot operations, such as the XSC boot code needed to boot system 210. Integrity module 302 of DAM 300 may generate integrity information for the XSC boot code. The integrity information may comprise, for example, a message digest created using the SHA hashing algorithm. Authentication module 304 of DAM 300 may encrypt the integrity information using a public key encryption scheme. The integrity information may be encrypted using either the public key or the private key, depending on a given implementation. The encrypted integrity information may be communicated to closed processing system 202.

Closed processing system 202 may receive the encrypted integrity information for the XSC boot code from open processing system 210. Authentication module 304 of DAM 300 may decrypt the encrypted integrity information using the corresponding public key or private key for open processing system 210. Authentication module 304 may also authenticate that the integrity information originated from open processing system 210, and was not tampered with during transmission. Authentication module 304 may pass the decrypted integrity information to attestation module 306 of DAM 300.

Attestation module 306 may receive the decrypted message digest, and instruct integrity module 302 of DAM 300 to retrieve a previously generated message digest for the original target application, e.g., the XSC boot code for closed processing system 210. The second message digest may have been generated by a validation entity using the same cryptographic operations used by integrity module 302 to generate the first message digest. The second message digest may be stored in a trusted area of system 200. Integrity module 302 may retrieve the stored second message digest from the trusted area of system 200. Integrity module 302 may send the second message digest to attestation module 306. Attestation module 306 may receive the second message digest, and compare the decrypted message digest with the second message digest. If the message digests are the same, then the integrity of the XSC boot code has been confirmed, and subsequent operations of open processing system 210 may proceed as normal. If the message digests are not the same, however, closed processing system 202 may assume that the integrity of the XSC boot code has been breached, and the appropriate security precautions may be taken to compartmentalize the breach. For example, closed processing system 202 may disable access to transceiver 218 by open processing system 210 to isolate the fault from system 100.

In another example similar to the one above, the trusted boot may be initiated by the open system booting from a trusted boot ROM. Having the platform attest to itself has the advantage that no other system then needs access to the memories and storage mechanisms on the device. After a basic check of the system is performed, the boot code may be passed to the MSA to initialize the closed system. They then initialize or verify their images in parallel. The dynamic attestation allows the applications for the open system to defer attesting to a significant portion of the stored code/content.

Numerous specific details may be set forth herein to provide a thorough understanding of the embodiments. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Portions of the embodiments may be implemented using an architecture that may vary in accordance with any number of factors, such as desired computational rate, power levels, heat tolerances, processing cycle budget, input data rates, output data rates, memory resources, data bus speeds and other performance constraints. For example, a portion of one embodiment may be implemented using software executed by a processor, as described previously. In another example, one embodiment may be implemented as dedicated hardware, such as an ASIC, Programmable Logic Device (PLD) or DSP and accompanying hardware structures. In yet another example, one embodiment may be implemented by any combination of programmed general-purpose computer components and custom hardware components. The embodiments are not limited in this context.

The embodiments may have been described in terms of one or more modules. Although an embodiment has been described in terms of “modules” to facilitate description, one or more circuits, components, registers, processors, software subroutines, or any combination thereof could be substituted for one, several, or all of the modules. The embodiments are not limited in this context.

While certain features of the embodiments have been illustrated as described herein, many modifications, substitutions, changes and equivalents will now occur to those skilled in the art. It is, therefore, to be understood that the appended claims are intended to cover all such modifications and changes as fall within the true spirit of the embodiments.

1. A method, comprising:
generating a first set of integrity information for a first processing system;
sending said first set of integrity information to a second processing system; and
generating an attestation value for said first processing system by said second processing system using said first set of integrity information.

2. The method of claim 1, wherein generating said first set of integrity information comprises:
selecting an application from a plurality of applications to be executed by said first processing system; and
generating said first set of integrity information for said application using a cryptographic algorithm.

3. The method of claim 1, wherein generating said attestation value comprises:
retrieving a second set of integrity information for said first processing system;
comparing said first set of integrity information with said second set of integrity information; and
generating said attestation value in accordance with said comparison.

4. The method of claim 1, wherein said sending comprises:
encrypting said integrity information using a first key for said first processing system; and
sending said encrypted integrity information to said second processing system.

5. The method of claim 4, further comprising authenticating said integrity information prior to generating said attestation value.

6. The method of claim 5, wherein said authenticating comprises:
receiving said encrypted integrity information;
retrieving a second key for said first processing system; and
decrypting said encrypted integrity information using said second key.

7. A method, comprising:
generating a first set of integrity information for a first process;
sending said first set of integrity information to a second process; and
generating an attestation value for said first process by said second process using said first set of integrity information.

8. The method of claim 7, wherein said first process and said second process are executed by different processing systems.

9. A system, comprising:
an antenna;
a transceiver to connect to said antenna;
a first processing system to connect to said transceiver, said first processing comprising a plurality of applications;
a second processing system to connect to said transceiver and said first processing system; and
a dynamic attestation module to connect to said first and second processing systems, said second processing system to perform dynamic attestation for one of said applications to be executed by said first processing system using said dynamic attestation module.

10. The system of claim 9, wherein said dynamic attestation module comprises an integrity module to generate a first set of integrity information for said application.

11. The system of claim 10, wherein said dynamic attestation module retrieves a second set of integrity information for said application.

12. The system of claim 11, wherein said dynamic attestation module comprises an attestation module to generate an attestation value for said application by comparing said first set of integrity information with said second set of integrity information.

13. The system of claim 10, wherein said dynamic attestation module comprises an authentication module to authenticate said first set of integrity information.

14. The system of claim 12, wherein said second processing system communicates control signals to said transceiver, said second processing system to disable access to said transceiver by said first processing system in accordance with said attestation value.

15. An apparatus, comprising:
a first processing system comprising a plurality of applications;
a second processing system to connect to said first processing system; and
a dynamic attestation module to connect to said first and second processing systems, said second dynamic attestation module to perform dynamic attestation for one of said applications.

16. The apparatus of claim 15, wherein said dynamic attestation module comprises an integrity module to generate a first set of integrity information for said application.

17. The apparatus of claim 16, wherein said dynamic attestation module retrieves a second set of integrity information for said application.

18. The apparatus of claim 17, wherein said dynamic attestation module comprises an attestation module to generate an attestation value for said application by comparing said first set of integrity information with said second set of integrity information.

19. The apparatus of claim 16, wherein said dynamic attestation module comprises an authentication module to authenticate said first set of integrity information.

20. An article comprising:
a storage medium;
said storage medium including stored instructions that, when executed by a processor, are operable to generate a first set of integrity information for a first processing system, send said first set of integrity information to a second processing system, and generate an attestation value for said first processing system by said second processing system using said first set of integrity information.

21. The article of claim 20, wherein the stored instructions, when executed by a processor, generate said first set of integrity information using stored instructions operable to select an application from a plurality of applications to be executed by said first processing system, and generate said first set of integrity information for said application using a cryptographic algorithm.

22. The article of claim 20, wherein the stored instructions, when executed by a processor, generate said attestation value using stored instructions operable to retrieve a second set of integrity information for said first processing system, compare said first set of integrity information with said second set of integrity information, and generate said attestation value in accordance with said comparison.
